(19) United States
(12) Patent Application Publication
(10) Pub. No.: US 2026/0221498 A1
(43) Pub. Date: Jul. 30, 2026

(54) METHOD FOR PRODUCING SULFIDE-BASED SOLID ELECTROLYTE

(71) Applicant: SK On Co., Ltd., Seoul (KR)

(72) Inventor: Ji Su BACK, Daejeon (KR)

(21) Appl. No.: 19/440,680

(22) Filed: Jan. 6, 2026

(30) Foreign Application Priority Data
Jan. 24, 2025 (KR) 10-2025-0011051

(51) Int. Cl. H01M 10/0562

(52) U.S. Cl. CPC H01M 10/0562; H01M 2300/0068

(57) ABSTRACT

The present disclosure provides a method for producing a sulfide-based solid electrolyte, in which a tetrahydrofuran-based organic solvent capable of dissolving most of a precursor mixture in a continuous phase and preventing an undissolved precursor mixture from generating precipitates caused by side reactions is used to produce a sulfide-based solid electrolyte having high purity and high ionic conductivity.

### CROSS-REFERENCE TO RELATED APPLICATIONS

This application claims priority under 35 U.S.C. § 119 to Korean Patent Application No. 10-2025-0011051, filed on Jan. 24, 2025, in the Korean Intellectual Property Office, the disclosure of which is incorporated herein by reference in its entirety.

### TECHNICAL FIELD

The following disclosure relates to a method for producing a sulfide-based solid electrolyte.

### BACKGROUND

Because lithium-ion secondary batteries have excellent energy density, such lithium-ion secondary batteries have been used in mobile information terminals, household electrical appliances, and portable small devices, and have recently been applied to batteries for electric vehicles as instability in international crude oil prices and environmental pollution resulting from global carbon emissions have become increasingly significant. A lithium-ion secondary battery generally includes key components such as a positive electrode material, a negative electrode material, an electrolyte solution, and a separator, and the key components of the lithium-ion secondary battery are known to directly affect the performance of the lithium-ion secondary battery, including battery capacity, safety, cycle life, charging rate, and output characteristics.

Among the key components of the lithium-ion secondary battery, the electrolyte solution is flammable, corrosive, thermally unstable, and vulnerable to high voltage. Therefore, a lithium-ion secondary battery containing such an electrolyte solution may cause thermal runaway when overheating, overcharging, or short-circuiting occurs due to internal or external factors, and therefore cannot ensure stability. Accordingly, all-solid-state lithium-ion secondary batteries using a solid electrolyte instead of a liquid electrolyte have recently been preferred as lithium-ion secondary batteries that are required to have large capacity and high stability.

Among conventional solid electrolytes, an inorganic solid electrolyte has no risk of liquid leakage and exhibits high ionic conductivity and excellent stability in high-voltage solid regions. Since the 2000s, various sulfide-based electrolytes have been developed, and research on sulfide-based solid electrolytes having higher ionic conductivity and excellent thermal stability has been most actively conducted.

For mass production, it is advantageous that sulfide-based solid electrolytes are produced by a wet synthesis method. However, the wet synthesis method for the sulfide-based solid electrolyte has difficulty in satisfying the levels of purity and ionic conductivity that have been recently required.

Therefore, it is essential to develop a novel production method capable of producing a sulfide-based solid electrolyte having the levels of purity and ionic conductivity that have been recently required, even by a wet synthesis method.

### SUMMARY

An embodiment of the present disclosure is directed to providing a method for producing a sulfide-based solid electrolyte having uniform particle diameter, high purity, and high ionic conductivity, even by a wet synthesis method using an organic solvent.

In one general aspect, a method for producing a sulfide-based solid electrolyte includes preparing a precursor solution by dissolving a precursor mixture containing lithium sulfide and phosphorus sulfide in a tetrahydrofuran-based organic solvent represented by the following Chemical Formula 1:

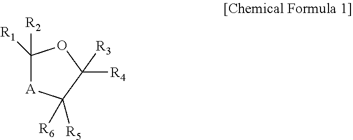

wherein A is *—C(═O)—* or *—C(R₇R₈)—*, R₁ to R₈ are hydrogen, linear or branched C₁-C₆ alkyl, linear or branched C₁-C₆ haloalkyl, or *-A₁-(C═O), two adjacent substituents may be linked to form an alicyclic ring or a heteroalicyclic ring, at least one of R₁ and R₂ is not hydrogen, and A₁ in *-A₁-(C═O) is a single bond or linear or branched C₁-C₆ alkylene.

In an exemplary embodiment of the present disclosure, in Chemical Formula 1, A may be *—C(═O)—* or *—C(R₇R₈)—*, R₁ and R₂ may each independently be hydrogen or linear or branched C₁-C₄ alkyl, provided that at least one of R₁ and R₂ is linear or branched C₁-C₄ alkyl, R₃ and R₄ may each independently be hydrogen, linear or branched C₁-C₆ alkyl, or *-A₁-(C═O), R₅ to R₈ may be hydrogen or linear or branched C₁-C₆ alkyl, R₂ and R₃, and R₄ may be linked to form an alicyclic ring, and A₁ in *-A₁-(C═O) may be a single bond, methylene, or ethylene.

In an exemplary embodiment of the present disclosure, the tetrahydrofuran-based organic solvent may be one or two or more selected from 2-methyltetrahydrofuran, 2,5-dimethyltetrahydrofuran, 1,4-epoxycyclohexane, tetrahydro-2-furancarboxaldehyde, and 2-methyltetrahydrofuran-3-one.

In an exemplary embodiment of the present disclosure, the method for producing a sulfide-based solid electrolyte may further include filtering the precursor solution.

In an exemplary embodiment of the present disclosure, the precursor solution may contain the precursor mixture in an amount of 0.01 to 0.5 g/ml.

In an exemplary embodiment of the present disclosure, the amount of precipitate after standing for 24 hours may be 0.5% by weight or less based on 100% by weight of the precursor mixture contained in the precursor solution.

In an exemplary embodiment of the present disclosure, the precursor solution may include lithium sulfide and phosphorus sulfide in a molar ratio of 1:0.1 to 1:1.

In an exemplary embodiment of the present disclosure, the sulfide-based solid electrolyte may have a purity of 98.0% or higher.

In an exemplary embodiment of the present disclosure, the sulfide-based solid electrolyte may have an ionic conductivity of 0.5 mS/cm or more as measured in accordance with ASTM D991.

In an exemplary embodiment of the present disclosure, the sulfide-based solid electrolyte may have an average particle diameter (D50) of 0.5 to 3.0 μm and a Span value of 2.0 or less.

In an exemplary embodiment of the present disclosure, the precursor solution may further include a lithium halide salt solution in which a metal halide salt is dissolved.

In an exemplary embodiment of the present disclosure, the method for producing a sulfide-based solid electrolyte may further include producing the sulfide-based solid electrolyte by drying and calcining the precursor solution.

Other features and aspects will be apparent from the following detailed description, the drawings, and the claims.

### BRIEF DESCRIPTION OF THE DRAWINGS

FIG. 1 shows the XRD measurement results of β—Li₃PS₄ produced in Example 1.

FIG. 2 shows the XRD measurement results of Li₆PS₅Cl produced in Example 4.

FIG. 3 shows the particle diameter analysis results of β-Li₃PS₄ produced in Example 1.

FIG. 4 shows the particle diameter analysis results of Li₆PS₅Cl produced in Example 4.

FIG. 5 shows the EIS measurement results of β-Li₃PS₄ produced in Example 1.

FIG. 6 shows the EIS measurement results of Li₆PS₅Cl produced in Example 4.

### DETAILED DESCRIPTION OF EMBODIMENTS

Hereinafter, the present disclosure will be described. In this case, unless otherwise defined, all the technical terms and scientific terms used herein have the general meanings as commonly understood by those skilled in the art to which the present disclosure pertains, and the description for the known function and configuration unnecessarily obscuring the gist of the present disclosure will be omitted in the following description.

In addition, unless the context clearly indicates otherwise, singular forms used in the present disclosure may be intended to include plural forms.

In addition, unless otherwise specified, the units used in the present disclosure are based on weight. For example, a unit of “%” or “ratio” refers to a weight percent or a weight ratio, and unless otherwise defined, the weight percent refers to the percentage by weight of any one component in the entire composition.

In addition, a numerical range used in the present disclosure includes upper and lower limits and all values within the range, increments logically derived from a form and span of a defined range, all doubly limited values, and all possible combinations of the upper and lower limits in the numerical range defined in different forms. Unless otherwise specifically defined in the present specification of the present disclosure, values out of a numerical range that may occur due to experimental errors or rounded values also fall within the defined numerical range.

The term “comprise(s)” as used in the present disclosure is an open-ended description having a meaning equivalent to the term such as “include(s)”, “contain(s)”, “have (has)”, or “is/are characterized”, and does not exclude elements, materials, or processes which are not further listed.

The term “C₁-Cₙ” as used in the present disclosure may refer to having 1 to n carbon atoms.

The term “haloalkyl” as used in the present disclosure may refer to an alkyl in which hydrogen of the alkyl is substituted with one or more selected from F, Cl, Br, I, and At.

In recent years, as low-carbon regulations have been strengthened due to the depletion of fossil fuels and environmental pollution issues, research on lithium-ion secondary batteries requiring large capacity, rapid charging, and excellent stability has been actively conducted. Among lithium-ion secondary batteries, all-solid-state lithium-ion secondary batteries have excellent stability and high heat resistance, and therefore, research on sulfide-based solid electrolytes has been more actively conducted.

Although the development of a wet synthesis method is essential for the mass production of sulfide-based solid electrolytes, it is difficult to produce sulfide-based solid electrolytes having high purity by conventional wet synthesis methods for sulfide solid electrolytes. Accordingly, there is a need for a method for producing a sulfide-based solid electrolyte having high purity and high ionic conductivity even by a wet synthesis method.

The present disclosure relates to a method for producing a sulfide-based solid electrolyte having high purity and high ionic conductivity by a wet synthesis method using a specific tetrahydrofuran-based organic solvent.

Hereinafter, the method for producing a sulfide-based solid electrolyte will be described.

The present disclosure provides a method for producing a sulfide-based solid electrolyte, and the produced sulfide-based solid electrolyte may refer to a solid electrolyte including Li, P, and S, which may have a binary structure or a ternary structure. The crystallinity and types of ions contained in the sulfide-based solid electrolyte may be controlled depending on the precursor and reaction conditions used in the production method, and therefore, a more detailed description thereof will be described below.

As an exemplary embodiment of the present disclosure, the method for producing a sulfide-based solid electrolyte may include preparing a precursor solution by dissolving a precursor mixture containing lithium sulfide and phosphorus sulfide in a tetrahydrofuran-based organic solvent represented by the following Chemical Formula 1:

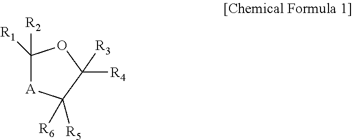

wherein A is *—C(═O)—* or *—C(R₇R₈)—*, R₁ to R₈ are hydrogen, linear or branched C₁-C₆ alkyl, linear or branched C₁-C₆ haloalkyl, or *-A₁-(C═O), two adjacent substituents may be linked to form an alicyclic ring or a heteroalicyclic ring, at least one of R₁ and R₂ is not hydrogen, and A₁ in *-A₁-(C═O) is a single bond or linear or branched C₁-C₆ alkylene.

In this case, as described above with reference to Chemical Formula 1, the method for producing a sulfide-based solid electrolyte is characterized in that tetrahydrofuran, which is used in conventional methods for producing a sulfide-based solid electrolyte, is not used.

Since the tetrahydrofuran-based organic solvent represented by Chemical Formula 1 exhibits excellent solubility for components to be introduced into the precursor mixture, such as lithium sulfide, phosphorus sulfide, and a lithium halide salt, which will be described below, and suppresses the phenomenon in which the dissolved precursor mixture prematurely reacts and precipitates, the produced sulfide-based solid electrolyte may have high homogeneity and high purity.

In addition, the tetrahydrofuran-based organic solvent may have a boiling point of 25° C. or higher, 30° C. or higher, 40° C. or higher, 50° C. or higher, 60° C. or higher, 70° C. or higher, 80° C. or higher, 90° C. or higher, 100° C. or higher, 110° C. or higher, 120° C. or higher, 130° C. or higher, 140° C. or higher, 150° C. or higher, or 160° C. or higher, and although the upper limit is not particularly limited, the boiling point may be 200° C. or lower, 190° C. or lower, or 180° C. or lower.

As described above, the tetrahydrofuran-based organic solvent has a structure similar to that of tetrahydrofuran, but may be preferred because it exhibits better solubility for the precursor mixture than tetrahydrofuran, and may also be preferred because it has a boiling point within the above-described range, thereby exhibiting better prevention of environmental pollution caused by volatilization at room temperature and higher stability. However, the boiling point is not limited to the above range.

In an exemplary embodiment of the present disclosure, in the tetrahydrofuran-based organic solvent, as represented by Chemical Formula 1, A may be *—C(═O)—* or *—C(R₇R₈)—*, R₁ and R₂ may each independently be hydrogen or linear or branched C₁-C₆ alkyl, provided that at least one of R₁ and R₂ may be linear or branched C₁-C₆ alkyl, R₃ and R₄ may each independently be hydrogen, linear or branched C₁-C₆ alkyl, or *-A₁-(C═O), R₅ to R₈ may be hydrogen or linear or branched C₁-C₆ alkyl, R₂ and R₃, and R₄ may be linked to form an alicyclic ring, and A₁ in *-A₁-(C—O) may be a single bond, methylene, or ethylene.

Alternatively, in an exemplary embodiment, in the tetrahydrofuran-based organic solvent, as represented by Chemical Formula 1, A may be *—C(═O)—* or *—C(R/R₈)—*, R₁ and R₂ may each independently be hydrogen or linear or branched C₁-C₄ alkyl, provided that at least one of R₁ and R₂ is linear or branched C₁-C₄ alkyl, R₃ and R₄ may each independently be hydrogen, linear or branched C₁-C₆ alkyl, or *-A₁-(C═O), R₅ to R₈ may be hydrogen or linear or branched C₁-C₆ alkyl, R₁ and R₂, and R₃ and R₄ may be linked to form an alicyclic ring, and A₁ in *-A₁-(C═O) may be a single bond or methylene.

In another exemplary embodiment of the present disclosure, the tetrahydrofuran-based organic solvent may be one or two or more selected from 2-methyltetrahydrofuran, 2,5-dimethyltetrahydrofuran, 1,4-epoxycyclohexane, tetrahydro-2-furancarboxaldehyde, and 2-methyltetrahydrofuran-3-one. Alternatively, as the tetrahydrofuran-based organic solvent, 2-methyltetrahydrofuran, 2,5-dimethyltetrahydrofuran, 1,4-epoxycyclohexane, tetrahydro-2-furancarboxaldehyde, or 2-methyltetrahydrofuran-3-one may be used alone.

The tetrahydrofuran-based organic solvent described above may minimize undissolved portions of the precursor mixture, thereby allowing most of the precursor mixture to be dissolved in a continuous phase, and even when the precursor solution is left to stand for a long period of time, the dissolved precursor mixture may not undergo a side reaction.

That is, the tetrahydrofuran-based organic solvent has excellent solubility for the precursor mixture, allowing a precursor solution to be prepared with an extremely small amount of dispersed-phase precursor, and the prepared precursor solution may generate only an extremely small amount of precipitate even after being left to stand for a long period of time. Therefore, since the sulfide-based solid electrolyte is produced from an almost continuous-phase precursor solution according to the method for producing a sulfide-based solid electrolyte, the produced sulfide-based solid electrolyte may have extremely high purity and high ionic conductivity.

In an exemplary embodiment of the present disclosure, the lithium sulfide is not particularly limited as long as it is composed of Li and S, but may be one or two or more selected from Li₂S, Li₂S₂, Li₂S₃, Li₂S₄, Li₂S₆, and Li₂S₈. In another exemplary embodiment, the lithium sulfide may include Li₂S, or may be Li₂S alone.

The produced sulfide-based solid electrolyte including Li₂S may have superior ionic conductivity and thus may be preferred; however, the present disclosure is not limited thereto as long as the physical properties are not impaired.

In an exemplary embodiment of the present disclosure, the phosphorus sulfide is not particularly limited as long as it is composed of S and P, but may be, for example, phosphorus sesquisulfide (P₂S₃) and/or phosphorus pentasulfide (P₂S₅). In another exemplary embodiment, phosphorus pentasulfide may be preferred in view of excellent reactivity with lithium sulfide and enabling preparation of a sulfide-based solid electrolyte without deviation from the stoichiometric ratio; however, the present disclosure is not limited thereto.

In an exemplary embodiment of the present disclosure, in the method for producing a sulfide-based solid electrolyte, when the precursor solution described above is composed of lithium sulfide and phosphorus sulfide, the produced sulfide-based solid electrolyte may be Li₃PS₄.

The Li₃PS₄ may preferably be β-Li₃PS₄, which has the highest ionic conductivity among α-Li₃PS₄, β-Li₃PS₄, and γ-Li₃PS₄; however, the Li₃PS₄ may contain only one of them, or may contain two or all three of them.

In an exemplary embodiment of the present disclosure, the precursor solution may further include a metal halide salt solution containing a metal halide salt.

In the method for producing a sulfide-based solid electrolyte, a sulfide-based solid electrolyte produced by further including a metal halide salt solution may have higher ionic conductivity than the Li₃PS₄ described above and thus may be preferred.

The solvent of the metal halide salt solution is not particularly limited as long as it dissolves the metal halide salt, but an alcohol-based solvent such as methanol, ethanol, or butanol may be preferred.

In an exemplary embodiment of the present disclosure, the metal halide salt may include a metal salt containing sodium (Na), lithium (Li), boron (B), aluminum (Al), silicon (Si), phosphorus sulfur(S), germanium (Ge), arsenic (As), selenium (Se), tin (Sn), antimony (Sb), tellurium (Te), lead (Pb), bismuth (Bi), or a metal salt in which an oxygen element or a sulfur element is bonded to any of these elements.

In another exemplary embodiment of the present disclosure, the metal salt contained in the metal halide salt may be lithium (Li), phosphorus (P), or a mixture thereof, or may contain lithium (Li) alone, in view of the fact that the produced sulfide-based solid electrolyte contains a large amount of β-Li₃PS₄ and exhibits higher ionic conductivity when combined with β-Li₃PS₄.

In an exemplary embodiment of the present disclosure, the metal halide salt may include one or more halogen atoms selected from fluorine (F), chlorine (Cl), bromine (Br), and iodine (I), which are recognized by those skilled in the art, and, similarly to the above description, may preferably include chlorine alone to achieve higher ionic conductivity.

That is, in an exemplary embodiment of the present disclosure, the metal halide salt may be LiCl, and the sulfide-based solid electrolyte produced using the same may be Li₆PS₅Cl.

In an exemplary embodiment of the present disclosure, the precursor solution may include lithium sulfide and phosphorus sulfide in a molar ratio of 1:0.1 to 1:1.

The precursor solution including lithium sulfide and phosphorus sulfide in the above molar ratio may be preferred because it enables the production of a sulfide-based solid electrolyte having high ionic conductivity targeted in the present disclosure.

In an exemplary embodiment of the present disclosure, when the precursor solution does not include a metal halide salt, the precursor solution may include lithium sulfide and phosphorus sulfide in a molar ratio of 1:0.1 to 1:0.5, or preferably in a molar ratio of 1:0.3 to 1:0.4, thereby minimizing unreacted precursors and enabling the production of β-Li₃PS₄ having excellent physical properties.

In another exemplary embodiment of the present disclosure, when the precursor solution includes a metal halide salt, the precursor solution may include lithium sulfide and phosphorus sulfide in a molar ratio of 1:0.1 to 1:0.4, and may also include lithium sulfide and phosphorus sulfide in a molar ratio of 1:0.1 to 0.3 or 1:0.15 to 0.25.

In addition, when the precursor solution further includes a metal halide salt, the metal halide salt may be included in an amount of 10 to 50 mol, 10 to 40 mol, or 15 to 25 mol with respect to 100 mol of lithium sulfide.

In an exemplary embodiment of the present disclosure, the precursor solution may contain a precursor mixture in an amount of 0.01 to 0.5 g/ml, and in another exemplary embodiment, the precursor solution may contain the precursor mixture in an amount of 0.01 to 0.3 g/ml, 0.01 to 0.1 g/ml, 0.03 to 0.1 g/ml, or 0.03 to 0.06 g/ml.

The precursor solution having a concentration within the above range may be preferred because the precursor mixture contained in the precursor solution may be homogeneously dissolved and may exhibit excellent reactivity, and, after the reaction, the solvent-drying and calcination processability may also be excellent; however, the present disclosure is not limited thereto.

In an exemplary embodiment of the present disclosure, the amount of precipitate after standing for 24 hours may be 0.5% by weight or less, preferably 0.3% by weight or less, more preferably 0.2% by weight or less, and most preferably 0.1% by weight or less, or no precipitate may be generated, based on 100% by weight of the precursor mixture contained in the precursor solution.

Since the precursor solution uses the tetrahydrofuran-Formula 1 based organic solvent represented by Chemical described above, the precursor solution may prevent the dissolved precursor mixture from undergoing a side reaction and precipitating before the target sulfide-based solid electrolyte is formed.

Accordingly, the method for producing a sulfide-based solid electrolyte may use a wet synthesis method having high productivity using the tetrahydrofuran-based organic solvent described above, thereby enabling the production of a sulfide-based solid electrolyte having extremely high purity and a sulfide-based solid electrolyte having high ionic conductivity, as compared with conventional methods for producing a sulfide-based solid electrolyte.

In an exemplary embodiment of the present disclosure, the method for producing a sulfide-based solid electrolyte may further include a filtering step of filtering the precursor solution, to produce a sulfide-based solid electrolyte that is more uniform and has higher purity.

In the method for producing a sulfide-based solid electrolyte, when a metal halide salt solution is further included, a precursor a solution obtained by dissolving precursor mixture in which lithium sulfide and phosphorus sulfide are mixed may be filtered, and then, the metal halide salt solution may be mixed, or a precursor solution further including the metal halide salt solution may be filtered.

The precursor solution prepared by further including the filtering step may remove even a trace amount of undissolved precursor mixture, such that the produced sulfide-based solid electrolyte may have higher purity and thus may exhibit higher ionic conductivity.

In an exemplary embodiment of the present disclosure, the preparing of the precursor solution is not particularly limited, but may involve stirring at 20 to 50° C., and may involve stirring at 30 to 50° C. or 40 to 50° C.

In addition, in the preparing of the precursor solution, a tetrahydrofuran-based organic solvent having excellent solubility for the precursor mixture may be used, and the mixture may be stirred for 15 hours or shorter, or 13 hours or shorter; however, the present disclosure is not limited thereto as long as the precursor mixture is dissolved in a continuous phase as intended in the present disclosure.

In an exemplary embodiment of the present disclosure, the method for producing a sulfide-based solid electrolyte may further include, after the preparing of the precursor solution described above, producing the sulfide-based solid electrolyte by drying and calcining the precursor solution.

The producing of the sulfide-based solid electrolyte may include drying the precursor solution at 80 to 100° C. and performing a heat treatment on the precursor solution at 150 to 250° C.

Since the producing of the sulfide-based solid electrolyte is already known in the art, it will be described in detail in the examples.

In an exemplary embodiment of the present disclosure, in the method for producing a sulfide-based solid electrolyte, a precursor solution in which most of the precursor mixture is dissolved in a continuous phase may be prepared by using the tetrahydrofuran-based organic solvent represented by Chemical Formula 1 described above.

In addition, the prepared precursor solution may hardly generate any precipitate caused by side reactions other than the sulfide-based solid electrolyte targeted in the present disclosure even when left to stand for a long period of time, and, as a result, a sulfide-based solid electrolyte having the following physical properties may be produced.

In an exemplary embodiment of the present disclosure, the sulfide-based solid electrolyte may have an average particle diameter (D50) of 0.5 to 3.0 μm and an extremely uniform particle diameter (D50) with a Span value of 2.0 or less.

When the sulfide-based solid electrolyte does not include a lithium halide salt solution in which a metal halide salt is dissolved, the average particle diameter (D50) may be 0.5 μm or more, 0.6 μm or more, 0.7 μm or more, 0.8 μm or more, 1.0 μm or more, 2.0 μm or less, or 1.5 μm or less. For example, the average particle diameter (D50) may be 0.5 to 2.0 μm or 0.5 to 1.5 μm, but is not limited thereto.

When the sulfide-based solid electrolyte is produced by further including a metal halide salt, the average particle diameter (D50) may be 1.0 μm or more, 1.5 μm or more, 2.0 μm or more, or 3.0 μm or less. For example, the average particle diameter (D50) may be 1.0 to 3.0 μm, 1.5 to 3.0 μm, or 2.0 to 3.0 μm, but is not limited thereto.

In another exemplary embodiment of the present disclosure, the sulfide-based solid electrolyte may have a Span value of 2.0 or less, 1.8 or less, 1.7 or less, 1.6 or less, 1.5 or less, 1.3 or less, or 1.2 or less. Although the lower limit is not limited, the Span value may be 1.0 or more or 1.1 or more.

Since sulfide-based solid electrolyte has an extremely uniform average particle diameter, a process of manufacturing an all-solid-state battery using the same may exhibit excellent consistency and reproducibility. In addition, the sulfide-based solid electrolyte having a uniform average particle diameter may be preferred because an all-solid-state electrolyte layer produced using the same has a highly uniform dispersibility, thereby improving the performance of an all-solid-state battery.

In an exemplary embodiment of the present disclosure, in the method for producing a sulfide-based solid electrolyte, the sulfide-based solid electrolyte may have a purity of 98.0% or more, 98.5% or more, 99.0% or more, 99.5% or more, 99.8% or more, 99.9% or more, or less than 100%.

In an exemplary embodiment of the present disclosure, in the method for producing a sulfide-based solid electrolyte, the produced sulfide-based solid electrolyte may have an ionic conductivity of 0.5 mS/cm or more, 0.7 mS/cm or more, 0.8 mS/cm or more, 0.9 mS/cm or more, 1.0 mS/cm or more, 1.2 mS/cm or more, 1.5 mS/cm or more, 1.8 mS/cm or more, 2.0 mS/cm or more, 2.5 mS/cm or more, 8.0 mS/cm or less, 7.5 mS/cm or less, 7.0 mS/cm or less, 6.5 mS/cm or less, 6.0 mS/cm or less, or 5.0 mS/cm or less, as measured in accordance with ASTM D991. For example, the produced sulfide-based solid electrolyte may have an ionic conductivity of 0.5 to 8.0 mS/cm, 0.7 to 8.0 mS/cm, 0.8 to 8.0 mS/cm, 0.9 to 8.0 mS/cm, 1.0 to 8.0 mS/cm, 1.5 to 8.0 mS/cm, 1.8 to 8.0 mS/cm, 2.0 to 8.0 mS/cm, or 2.2 to 8.0 mS/cm.

Therefore, even when the sulfide-based solid electrolyte is produced by a wet synthesis method that allows mass production, the method for producing a sulfide-based solid electrolyte may produce a sulfide-based solid electrolyte having the high purity and high ionic conductivity described above.

Hereinafter, the present disclosure will be described in more detail based on the following examples and comparative examples. However, the following examples and comparative examples are only examples for explaining the present disclosure in more detail, and the present disclosure is not limited by the following examples and comparative examples.

### [Measurement Methods]

### 1. X-Ray Diffraction (XRD) Measurement

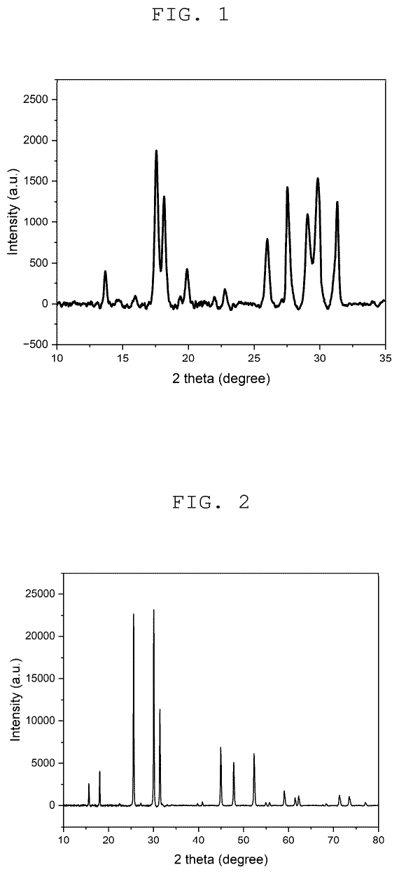

A measurement sample was prepared by molding a circular pellet having a diameter of 10 mm and a height of 0.1 cm from the powder of the produced sulfide-based solid electrolyte. The measurement was performed using an airtight sample holder for XRD without exposing the sample to air. The 20 positions of the diffraction peaks were determined by the centroid method using the XRD analysis program JADE. The measurement sample was measured under the following measurement conditions using an XRD instrument (XRD-03, Empyrean). The XRD data of the measurement sample were examined, and the purity was calculated by identifying the Li₃PS₄ or Li₆PS₅Cl peaks. The XRD measurement result of β-Li₃PS₄ produced in Example 1 is shown in FIG. 1, and the XRD measurement result of Li₆PS₅Cl produced in Example 4 is shown in FIG. 2.
X-ray Source Anode: Cu
Tube voltage: 45 kV
Tube current: 40 mA
Incident beam: BBHD
Divergence slit: ¼°
Anti-scatter slit: 1°
Detector: PIXcel detector
Sample stage: Reflection-transmission spinner

### 2. Measurement of Particle Diameter

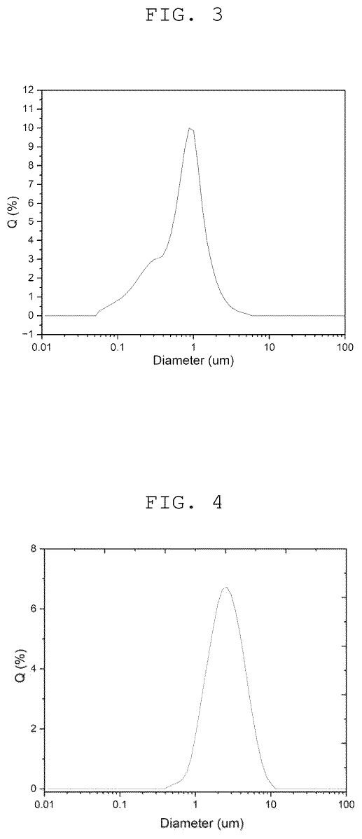

The particle diameter was measured using a Mastersizer 3000 (Malvern Panalytical Ltd.) by a dynamic laser light scattering method, based on an intensity Gaussian distribution (Nicompnano N3000), and “Dn” (where n is a real number) refers to the particle diameter corresponding to an n % cumulative volume fraction. For example, “D50” refers to the particle diameter corresponding to a 50% cumulative volume fraction. The average particle diameter (D50) and the Span value measured by the above particle diameter measurement method are shown in Table 2. In addition, the results of the particle diameter measurement of β-Li₃PS₄ produced in Example 1 are shown in FIG. 3, and the results of the particle diameter measurement of Li₆PS₅Cl produced in Example 4 are shown in FIG. 4.

### 3. Measurement of Long-Term Solubility of Precursor Solution

After the precursor solution was left to stand at room temperature for 24 hours, the precipitate was filtered and its mass was measured. Thereafter, the long-term solubility of the precursor solution was calculated as a percentage of the mass of the precipitate with respect to the total amount of solids charged in the preparation of the precursor solution.

### 4. Measurement of Ionic Conductivity

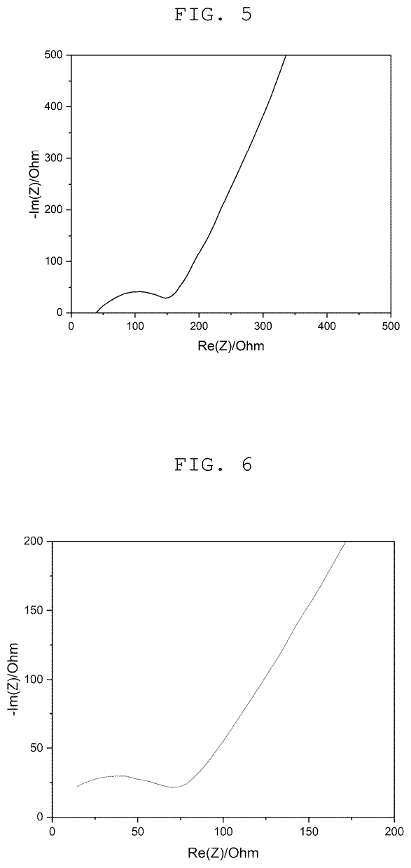

The ionic conductivity was measured at room temperature (25° C.) using electrochemical impedance spectroscopy (EIS). The ionic conductivity was evaluated using a pressure cell after pressing 100 mg of the sulfide-based solid electrolyte powder at a pressure of 370 MPa, at a confining pressure of 65 MPa. In this case, stainless steel (SS) was used as the blocking electrode. The ionic conductivity was measured at a voltage of 100 mV in a frequency range of 5 MHz to 100 MHz, and the ionic conductivity was calculated according to the following equation. The results of the EIS measurement of β-Li₃PS₄ produced in Example 1 are shown in FIG. 5, and the results of the EIS measurement of Li₆PS₅Cl produced in Example 4 are shown in FIG. 6.

$$Ionic conductivity ( σ ) = \frac{1}{R} \times \frac{A}{l} \qquad [ Equation ]$$

In the equation, R is the ionic resistance of the measurement sample, A is the area of the measurement sample, and 1 is the thickness of the measurement sample.

### Example 1

60 ml of 2-methyltetrahydrofuran was placed in a stirrer, the inside of the stirrer was purged with argon gas, 3 g of a precursor obtained by mixing Li₂S and P₂S₅ in a molar ratio of 3:1 was then charged into the reactor, and the mixture was stirred at 55° C. for 12 hours, thereby preparing a precursor solution. After stirring was completed, the prepared precursor solution was filtered through a filter (pore size: G4) to remove impurities remaining in the precursor solution, thereby preparing a continuous-phase precursor solution.

The continuous-phase precursor solution prepared as described above was dried at 100° C. under reduced pressure, and then subjected to a heat treatment at 200° C. in a sealed state, thereby producing β-Li₃PS₄.

Thereafter, the produced β-Li₃PS₄ was measured by the above measurement methods, and the results are shown in Table 2.

### Example 2

β-Li₃PS₄ was produced in the same manner as in Example 1, except that 60 ml of 2,5-dimethyltetrahydrofuran was used instead of 60 ml of 2-methyltetrahydrofuran.

Thereafter, the produced β-Li₃PS₄ was measured by the above measurement methods, and the results are shown in Table 2.

### Example 3

β-Li₃PS₄ was produced in the same manner as in Example 1, except that the prepared precursor solution was not filtered.

Thereafter, the produced β-Li₃PS₄ was measured by the above measurement methods, and the results are shown in Table 2.

### Example 4

60 ml of 2-methyltetrahydrofuran was placed in a stirrer, the inside of the stirrer was purged with argon gas, 3 g of a precursor obtained by mixing Li₂S and P₂S₅ in a molar ratio of 5:1 was then charged into the reactor, and the mixture was stirred at 45° C. for 12 hours, thereby preparing a first precursor solution. After stirring was completed, the prepared precursor solution was filtered through a filter (pore size: G4) to remove impurities remaining in the first precursor solution, thereby preparing a continuous-phase first precursor solution.

Subsequently, the continuous-phase first precursor solution prepared as described above was mixed with a lithium chloride solution prepared by stirring LiCl and ethanol at room temperature so that the molar amount of LiCl was twice that of P₂S₅, and the mixture was stirred at 45° C. for 12 hours, thereby preparing a second precursor solution.

The prepared second precursor solution was dried at 150° C. under reduced pressure, and then subjected to a heat treatment at 550° C. under an argon flow, thereby producing Li₆PS₅Cl.

Thereafter, the produced Li₆PS₅Cl was measured by the above measurement methods, and the results are shown in Table 2.

### Example 5

Li₆PS₅Cl was produced in the same manner as in Example 4, except that 60 ml of 2,5-dimethyltetrahydrofuran was used instead of 60 ml of 2-methyltetrahydrofuran.

Thereafter, the produced Li₆PS₅Cl was measured by the above measurement methods, and the results are shown in Table 2.

### Comparative Example 1

The procedure was performed in the same manner as in Example 1, except that 60 ml of tetrahydrofuran was used instead of 60 ml of 2-methyltetrahydrofuran.

The results are shown in Table 2.

### Comparative Example 2

The procedure was performed in the same manner as in Example 1, except that 30 ml of 2-methyltetrahydrofuran and 30 ml of tetrahydrofuran were used instead of 60 ml of 2-methyltetrahydrofuran.

The results are shown in Table 2.

### Comparative Example 3

The procedure was performed in the same manner as in Example 4, except that 60 ml of tetrahydrofuran was used instead of 60 ml of 2-methyltetrahydrofuran.

The results are shown in Table 2.

### Comparative Example 4

The procedure was performed in the same manner as in Example 4, except that 30 ml of 2-methyltetrahydrofuran and 30 ml of tetrahydrofuran were used instead of 60 ml of 2-methyltetrahydrofuran.

The results are shown in Table 2.

TABLE 1

| | | |
|---|---|---|
| | | Whether |
| | Amount of | filtering |
| | solvent used | is |
| Type of solvent used | (ml) | performed |

Production of β-Li₃PS₄

| | | | |
|---|---|---|---|
| Example 1 | 2-Methyltetrahydrofuran | 60 | ◯ |
| Example 2 | 2,5-dimethyl tetrahydrofuran | 60 | ◯ |
| Example 3 | 2-Methyltetrahydrofuran | 60 | X |
| Comparative | Tetrahydrofuran | 60 | ◯ |
| Example 1 | | | |
| Comparative | 2-Methyltetrahydrofuran | 30 | ◯ |
| Example 2 | Tetrahydrofuran | 30 | |

Production of Li₆PS₅Cl

| | | | |
|---|---|---|---|
| Example 4 | 2-Methyltetrahydrofuran | 60 | ◯ |
| Example 5 | 2,5-dimethyl tetrahydrofuran | 60 | ◯ |
| Comparative | Tetrahydrofuran | 60 | ◯ |
| Example 3 | | | |
| Comparative | 2-Methyltetrahydrofuran | 30 | ◯ |
| Example 4 | Tetrahydrofuran | 30 | |

TABLE 2

| | Measurement results | | | | |
|---|---|---|---|---|---|
| | | Average | | | Long-term |
| | | particle | Ionic | | lithium-ion |
| | Purity | diameter | conductivity | | solubility |
| | (%) | (μm) | (mS/cm) | Span | (% by weight) |
| Production | | | | | |
| of β-Li₃PS₄ | | | | | |
| Example 1 | 99.9 | 0.6 | 0.9 | 1.12 | 0.1 |
| Example 2 | 98.0 | 0.6 | 0.7 | 1.29 | 0.3 |
| Example 3 | 99.0 | 0.7 | 0.8 | 1.61 | 0.1 |
| Comparative | β-Li₃PS₄ not produced | | | | |
| Example 1 | | | | | |
| Comparative | 45 | 1.1 | 0.2 | 3.14 | 48 |
| Example 2 | | | | | |
| Production | | | | | |
| of Li₆PS₅Cl | | | | | |
| Example 4 | 99.9 | 2.4 | 2.2 | 1.62 | 0.1 |
| Example 5 | 98.0 | 2.3 | 1.8 | 1.61 | 0.2 |
| Comparative | Li₆PS₅Cl not produced | | | | |
| Example 3 | | | | | |
| Comparative | 35 | 2.9 | 0.8 | 2.31 | 53 |
| Example 4 | | | | | |

As shown in Table 2, it was confirmed that, in the precursor solutions of Examples 1 to 3, the amount of precipitate caused by side reactions was extremely small, at 0.5% by weight or less, even after being left to stand for a long period of time.

Accordingly, it was confirmed that β-Li₃PS₄ produced by the methods for producing a sulfide-based solid electrolyte of Examples 1 to 3 had a purity of 98.0% or higher and an ionic conductivity of 0.5 mS/cm or more.

In addition, as shown in Table 2, it was confirmed that Li₆PS₅Cl produced in Examples 4 and 5 by additionally including lithium chloride still had a high purity of 98.0% or higher and exhibited an even higher ionic conductivity of 1.8 mS/cm or more.

FIG. 1 shows the XRD measurement results of β-Li₃PS₄ produced in Example 1 according to the XRD measurement method described above, and it was confirmed that the peaks were sharp and there was almost no background noise.

As shown in FIG. 2, through the XRD measurement results of Li₃PS₅Cl produced in Example 4, it was confirmed that the peaks were sharp and narrow, the background noise was minimal, the crystal structure was uniform, and Li₆PS₅Cl was produced with high purity.

FIG. 3 shows the particle diameter analysis results of β-Li₃PS₄ produced in Example 1, confirming that the average particle diameter (D50) was 0.6 μm and a Span value was extremely narrow.

In addition, FIG. 4 shows the particle diameter analysis results of Li₆PS₅Cl produced in Example 4, confirming that, compared with the examples, Li₆PS₅Cl had a larger average particle diameter (D50) of 2.4 μm and, similar to Li₃PS₄ of Example 1, exhibited an extremely narrow Span value.

As described above and according to FIGS. 3 and 4, 3-Li₃PS₄ produced in Example 1 and Li₆PS₅Cl produced in Example 4 had small average particle diameters (D50) and uniform particle diameters, and therefore, an electrolyte solution containing them may exhibit excellent coating properties on the positive electrode.

FIG. 5 shows the EIS measurement results of β-Li₃PS₄ produced in Example 1 as described above, and FIG. 6 shows the results obtained by measuring Li₆PS₅Cl produced in Example 4 by the EIS measurement method described above.

As shown in FIGS. 5 and 6, the electrochemical reactions of β-Li₃PS₄ produced in Example 1 and Li₆PS₅Cl produced in Example 4 were identified from the resistance represented by the real part on the X-axis and the imaginary component on the Y-axis, and by substituting the resistance represented by the real part, it was confirmed that the electrical conductivities shown in Table 2 were obtained.

In contrast, as shown in Table 2, the precursor solution of Comparative Example 1 exhibited poor lithium-ion solubility to an extent that was not sufficient for long-term solubility, and β-Li₃PS₄ was not produced, unlike in Examples 1 to 3.

In addition, the precursor solution of Comparative Example 2 generated a large amount of precipitate when left to stand for a long period of time, as compared with the precursor solutions of Examples 1 to 3, and it was confirmed that the produced sulfide-based solid electrolyte had a non-uniform average particle diameter (D50) and exhibited reduced purity and ionic conductivity.

It was confirmed that, in the methods for producing a sulfide-based solid electrolyte of Comparative Examples 3 and 4, Li₆PS₅Cl could not be produced, or Li₆PS₅Cl having reduced purity and ionic conductivity was produced.

Accordingly, in the method for producing a sulfide-based solid electrolyte of the present disclosure, most of the precursor mixture dissolved in the precursor solution may be dissolved in a continuous phase, and no precipitate may be generated by side reactions. Thus, the method for producing a sulfide-based solid electrolyte of the present disclosure may not only produce sulfide-based solid electrolytes in large quantities, but also produce sulfide-based solid electrolytes having high purity and high ionic conductivity, and is therefore expected to enable the manufacture of high-performance all-solid-state lithium secondary batteries including the same.

As set forth above, in an exemplary embodiment of the present disclosure, the method for producing a sulfide-based solid electrolyte allows mass production and may exhibit an extremely high reaction rate, thereby enabling the production of a sulfide-based solid electrolyte with excellent processability and low production cost.

In an exemplary embodiment of the present disclosure, the method for producing a sulfide-based solid electrolyte enables the production of a sulfide-based solid electrolyte having excellent homogeneity and high purity.

In an exemplary embodiment of the present disclosure, the method for producing a sulfide-based solid electrolyte enables the production of a sulfide-based solid electrolyte having extremely high ionic conductivity, and therefore enables the manufacture of an all-solid-state battery including the produced sulfide-based solid electrolyte with excellent performance.

Hereinabove, although the present disclosure has been described by specific matters and limited examples and comparative examples, they have been provided only for assisting in the entire understanding of the present disclosure. Therefore, the present disclosure is not limited to the examples, and various modifications and changes may be made by those skilled in the art to which the present disclosure pertains from this description.

Therefore, the spirit of the present disclosure should not be limited to the described examples, but the claims and all modifications equal or equivalent to the claims are intended to fall within the spirit of the present disclosure.

What is claimed is:

1. A method for producing a sulfide-based solid electrolyte, the method comprising preparing a precursor solution by dissolving a precursor mixture containing lithium sulfide and phosphorus sulfide in a tetrahydrofuran-based organic solvent represented by the following Chemical Formula 1: 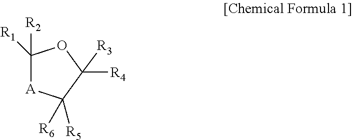
wherein
A is *—C(═O)—* or *—C(R₇R₈)—*,
R₁ to R₈ are hydrogen, linear or branched C₁-C₆ alkyl, linear or branched C₁-C₆ haloalkyl, or *-A₁-(C═O),
two adjacent substituents are linked to form an alicyclic ring or a heteroalicyclic ring,
at least one of R₁ and R₂ is not hydrogen, and
A₁ in *-A₁-(C═O) is a single bond or linear or branched C₁-C₆ alkylene.

2. The method of claim 1, wherein
in Chemical Formula 1,
A is *—C(═O)—* or *—C(R₇R₈)—*,
R₁ and R₂ are each independently hydrogen or linear or branched C₁-C₄ alkyl, provided that at least one of R₁ and R₂ is linear or branched C₁-C₄ alkyl,
R₃ and R₄ are each independently hydrogen, linear or branched C₁-C₆ alkyl, or *-A₁-(C═O),
R₅ to R₈ are hydrogen or linear or branched C₁-C₆ alkyl,
R₂ and R₃, and R₄ are linked to form an alicyclic ring, and
A₁ in *-A₁-(C═O) is a single bond, methylene, or ethylene.

3. The method of claim 1, wherein the tetrahydrofuran-based organic solvent is one or two or more selected from 2-methyltetrahydrofuran, 2,5-dimethyltetrahydrofuran, 1,4-epoxycyclohexane, tetrahydro-2-furancarboxaldehyde, and 2-methyltetrahydrofuran-3-one.

4. The method of claim 1, further comprising filtering the precursor solution.

5. The method of claim 1, wherein the precursor solution contains the precursor mixture in an amount of 0.01 to 0.5 g/ml.

6. The method of claim 1, wherein the amount of precipitate after standing for 24 hours is 0.5% by weight or less based on 100% by weight of the precursor mixture contained in the precursor solution.

7. The method of claim 1, wherein the precursor solution includes lithium sulfide and phosphorus sulfide in a molar ratio of 1:0.1 to 1:1.

8. The method of claim 1, wherein the sulfide-based solid electrolyte has a purity of 98.0% or higher.

9. The method of claim 1, wherein the sulfide-based solid electrolyte has an ionic conductivity of 0.5 mS/cm or more as measured in accordance with ASTM D991.

10. The method of claim 1, wherein the sulfide-based solid electrolyte has an average particle diameter (D50) of 0.5 to 3.0 μm and a Span value of 2.0 or less.

11. The method of claim 1, wherein the precursor solution further includes a lithium halide salt solution in which a metal halide salt is dissolved.

12. The method of claim 1, further comprising producing the sulfide-based solid electrolyte by drying and calcining the precursor solution.
